(19) United States
(12) Patent Application Publication
(10) Pub. No.: US 2026/0031681 A1
(43) Pub. Date: Jan. 29, 2026

(54) ELECTRIC MOTOR

(71) Applicant: Thumbs Up Innovations Technology Co., Ltd., Zhuhai (CN)

(72) Inventors: JIACHENG HUANG, Zhuhai (CN); XIU ZOU, Zhuhai (CN)

(21) Appl. No.: 18/796,382

(22) Filed: Aug. 7, 2024

(30) Foreign Application Priority Data
Jul. 29, 2024 (CN) 202421815076.5

(51) Int. Cl. H02K 9/06; H02K 3/26

(52) U.S. Cl. CPC H02K 9/06; H02K 3/26

(57) ABSTRACT

An electric motor includes a frame assembly, a stator assembly and a rotor assembly. The frame assembly includes a shell and at least one bearing frame. The shell has an inner wall and an outer wall. The inner wall defines a mounting channel. An annular channel is defined between the inner wall and the outer wall. Diffuser vanes are arranged in the annular channel. The bearing frame is connected to an end portion of the shell. The stator assembly is arranged in the mounting channel. The stator assembly includes a stator shell and a coil assembly. The stator assembly defines a mounting hole. The rotor assembly includes a magnet, a bearing, an impeller, and a rotating shaft. The rotor assembly is at least partially inserted into the mounting hole. The bearing is inserted into a mounting slot of the bearing frame.

### CROSS-REFERENCE TO RELATED APPLICATIONS

The application claims priority of Chinese patent application CN2024218150765, filed on Jul. 29, 2024, which is incorporated herein by reference in its entireties.

### TECHNICAL FIELD

The present disclosure relates to the technical field of motors, and in particular, to an electric motor.

### BACKGROUND

An electric motor is equipment that converts electrical energy into mechanical energy. The equipment has a wide range of applications in daily life, as large as automobiles and airplanes, and as small as toys and handheld small appliances, all of which use electric motors as power sources. In handheld products such as an electric toothbrush and a hair dryer, small-sized and highly stable electric motors are generally used.

At present, to miniaturize the products, in the existing electric motor, a bearing is directly arranged in a shell, so that a bearing mounting structure is arranged at the shell. This increases the difficulty of processing of the product, reduces the production efficiency, and easily produces defective products, causing troubles to product production. Moreover, the assembling of the product is more complicated, and the product has a complex structure and low stability.

Therefore, the present disclosure provides an electric motor that can effectively solve the above-mentioned problems. The electric motor has a simple and stable structure, and is convenient to produce and assembly.

### SUMMARY

In order to overcome the shortcomings of the prior art, the present disclosure provides an electric motor. The electric motor has a simple and stable structure, and is convenient to produce and assembly.

The technical solution adopted by the present disclosure to solve the technical problem is as follows.

An electric motor, includes:
a frame assembly, wherein the frame assembly includes a shell and at least one bearing frame; the shell has an inner wall and an outer wall; the inner wall defines a mounting channel; an annular channel is defined between the inner wall and the outer wall; diffuser vanes are arranged in the annular channel; the bearing frame is connected to an end portion of the shell;
a stator assembly, wherein the stator assembly is arranged in the mounting channel; the stator assembly includes a stator shell and a coil assembly; the stator assembly defines a mounting hole; and
a rotor assembly, wherein the rotor assembly includes a magnet, a bearing, an impeller, and a rotating shaft; the rotor assembly is at least partially inserted into the mounting hole; and the bearing is inserted into a mounting slot of the bearing frame.

As an improvement of the present disclosure, the bearing frame is provided with a connecting portion and an insertion portion; the mounting slot is arranged in the insertion portion; the connecting portion extends outwards along an edge of the insertion portion; and the connecting portion is connected to an end portion of the shell.

As an improvement of the present disclosure, the connecting portion is provided with a through hole, and the through hole is configured to allow an air flow to pass through.

As an improvement of the present disclosure, the electric motor further includes a shock absorber sleeve, the shock absorber sleeve sleeves the bearing; an inner surface of the shock absorber sleeve abuts against an outer surface of the bearing; an outer surface of the shock absorber sleeve is in contact with an inner wall of the mounting slot.

As an improvement of the present disclosure, the insertion portion is provided with a shaft hole; an output end of the rotating shaft is threaded out along the shaft hole, and the impeller is connected to the output end of the rotating shaft.

As an improvement of the present disclosure, a lower part of the inner wall of the shell protrudes inwards to form a mounting block; the mounting block is provided with a first connecting hole; the bearing frame is provided with a second connecting hole; and the first connecting hole and the second connecting hole are configured to allow a threaded connector to be inserted and connected, so that the bearing frame is connected to the shell.

As an improvement of the present disclosure, the stator shell is further provided with a connecting through hole; a threaded portion of the threaded connector passes through the second connecting hole and the connecting through hole, and is in threaded connection to the first connecting hole; a lower surface of the upper bearing frame resists against an upper surface of the stator shell; and a lower surface of the stator shell resists against the mounting block.

As an improvement of the present disclosure, a first mounting step is arranged at an edge of the shell; a second mounting step is arranged at an edge of the bearing frame; and the first mounting step resists against the second mounting step.

As an improvement of the present disclosure, the electric motor further includes a printed circuit board (PCB), the PCB is connected to an upper surface of the upper bearing frame and is electrically connected to the coil assembly.

As an improvement of the present disclosure, the rotor assembly further includes two shaft sleeves; the magnet sleeves the rotating shaft; and the two shaft sleeves sleeve the rotating shaft and respectively resist against two ends of the magnet.

As an improvement of the present disclosure, the electric motor further includes several electric connection pins, several electric contacts electrically connected to the coil assembly are arranged on an upper surface of the stator shell; lower ends of the electric connection pins are electrically connected to the electric contacts; and upper ends of the electric connection pins are electrically connected to the PCB.

As an improvement of the present disclosure, the electric motor further includes a shock absorber shell, the shock absorber shell sleeves an outer surface of the shell.

As an improvement of the present disclosure, the shock absorber shell is a silica gel material, and a protruding resisting portion is arranged on a surface of the shock absorber shell.

As an improvement of the present disclosure, the outer wall axially extends beyond the inner wall in at least one of an upstream direction and a downstream direction.

As an improvement of the present disclosure, the impeller includes an impeller main body and vanes; and the vanes uniformly extend outwards along a surface of the impeller main body.

As an improvement of the present disclosure, the vanes are located in a space enclosed by the outer wall.

As an improvement of the present disclosure, a diameter of a circle where outer surfaces of the vanes are located is matched with a diameter of an inner surface of the outer wall.

As an improvement of the present disclosure, each vane is shaped like an Archimedean spiral curved surface.

As an improvement of the present disclosure, the diffuser vanes extend along an outer surface of the inner wall to the inner surface of the outer wall, and the diffuser vanes are uniformly arranged in the annular channel at intervals.

As an improvement of the present disclosure, an electrostatic connecting block is arranged on the outer wall, and the electrostatic connecting block is configured to be electrically connected to a conductive component to eliminate static electricity.

Beneficial effects: By the arrangement of the above structure, the stator assembly is inserted into the mounting channel, and then the rotor assembly is inserted into the mounting hole, so that the stator assembly and the rotor assembly are coaxially arranged. In addition, the bearing frame is connected to the shell, and the bearing of the rotor assembly is inserted into the mounting slot of the bearing frame, so that the bearing frame can connect the rotor assembly with the shell, and the product connection is more stable. Moreover, the shell and the bearing frame separately arranged, which can reduce the production difficulty, improve the production efficiency, and increase the yield of the product. When in use, alternating current is provided to the coil assembly to generate a periodically changing magnetic field. The magnetic field generated by coil assembly interacts with a magnetic field of the magnet, thereby driving the magnet, the rotating shaft, and the impeller to rotate.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic diagram of an entire structure in an angle according to a first embodiment of the present disclosure;

FIG. 2 is a schematic diagram of an entire structure in another angle according to a first embodiment of the present disclosure;

FIG. 3 is a schematic diagram of an exploded structure in an angle according to a first embodiment of the present disclosure;

FIG. 4 is a schematic diagram of an exploded structure in another angle according to a first embodiment of the present disclosure;

FIG. 5 is a schematic diagram of a cross-sectional structure according to a first embodiment of the present disclosure;

FIG. 6 is an enlarged view of circle A in FIG. 5;

FIG. 7 is a schematic diagram of an entire structure of a shell according to a first embodiment of the present disclosure;

FIG. 8 is a schematic diagram of an entire structure of a bearing frame according to a first embodiment of the present disclosure;

FIG. 9 is a schematic diagram of an exploded structure in an angle according to a second embodiment of the present disclosure; and

FIG. 10 is a schematic diagram of an exploded structure in another angle according to a second embodiment of the present disclosure.

### DETAILED DESCRIPTION OF THE EMBODIMENTS

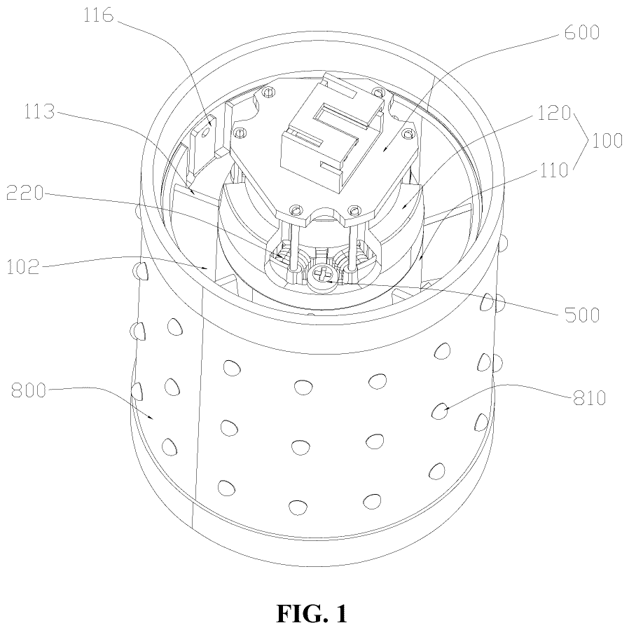

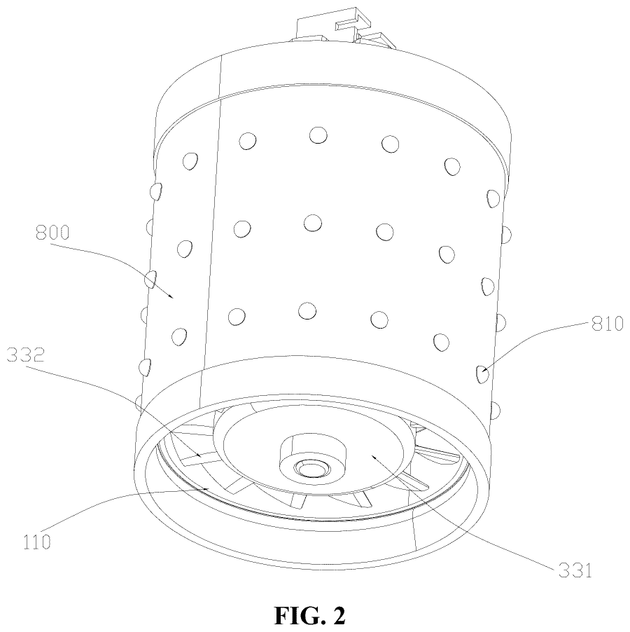

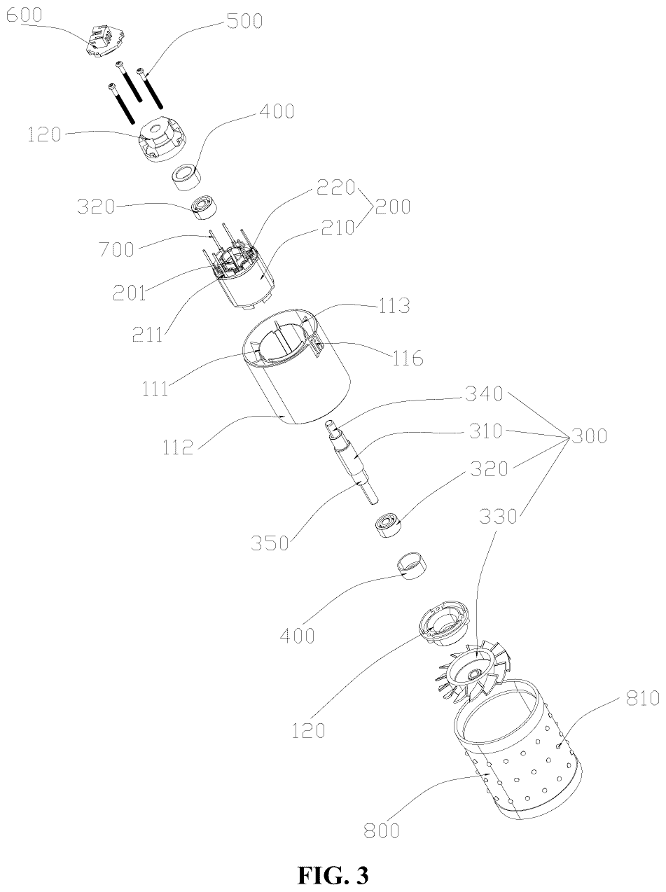

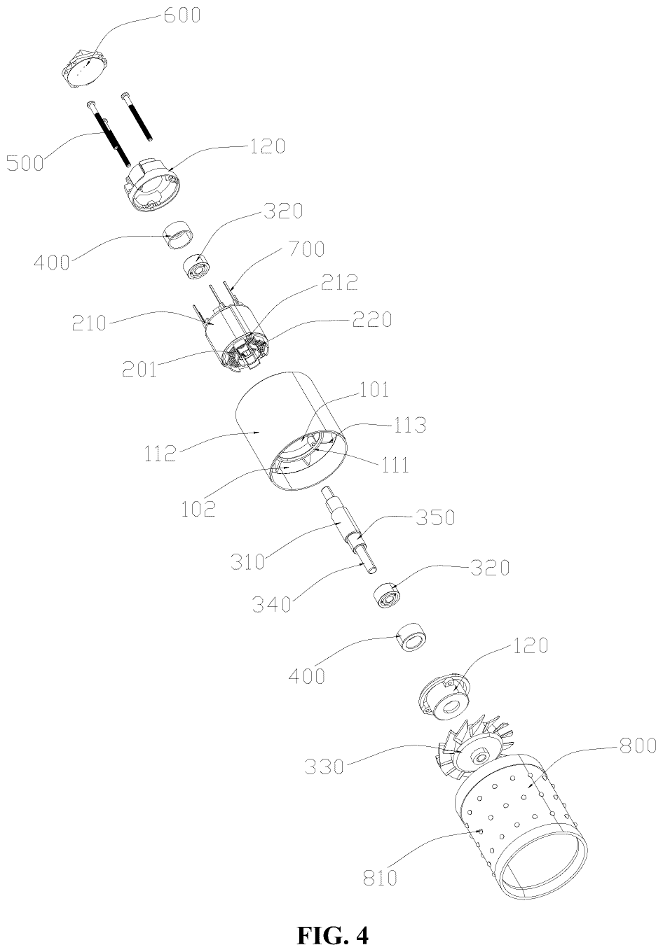

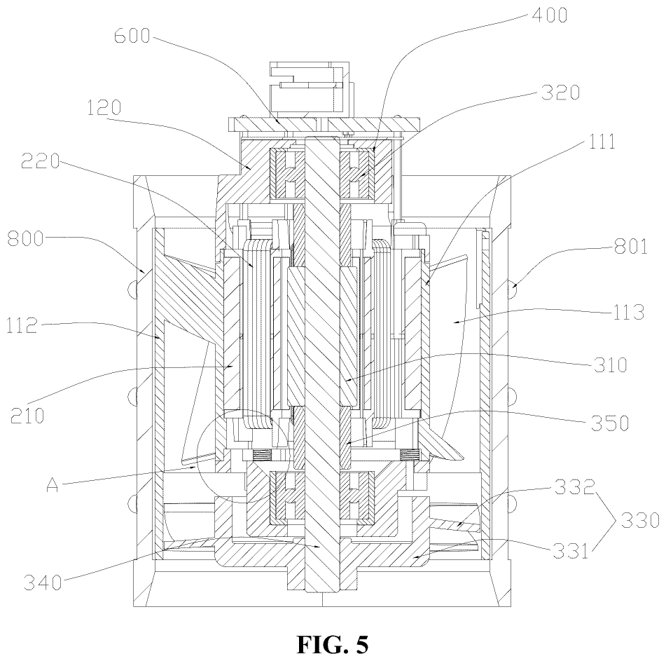

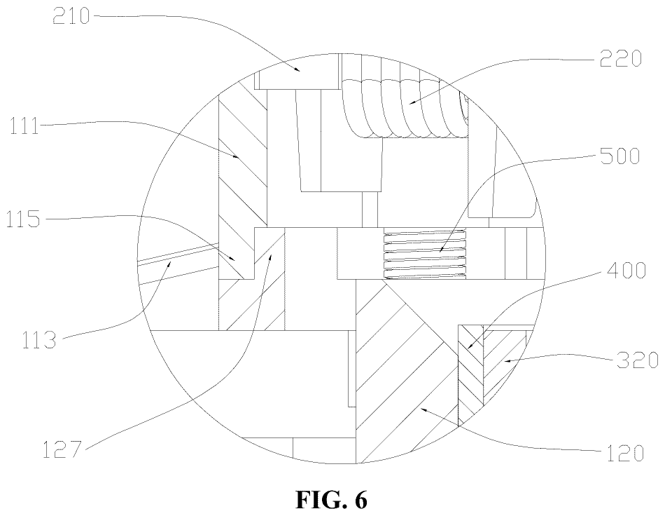

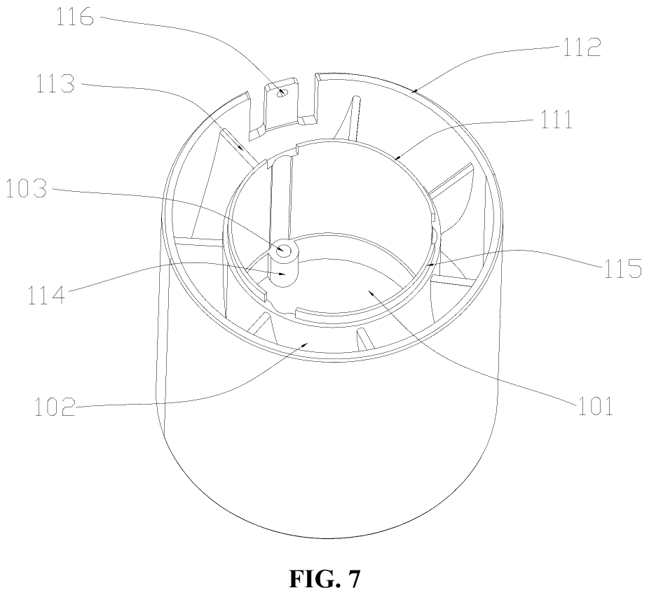

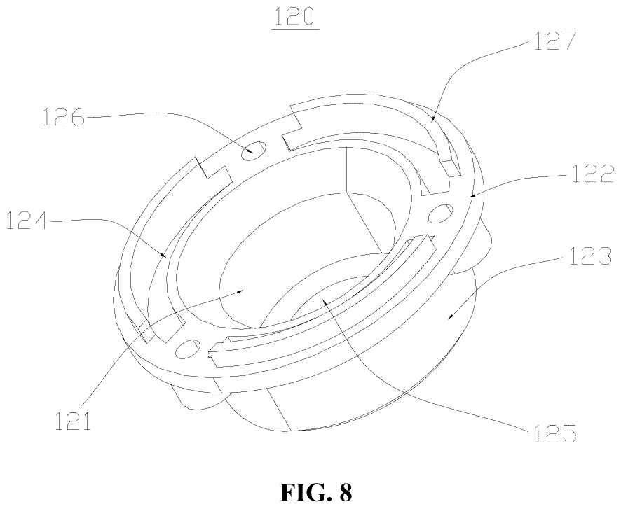

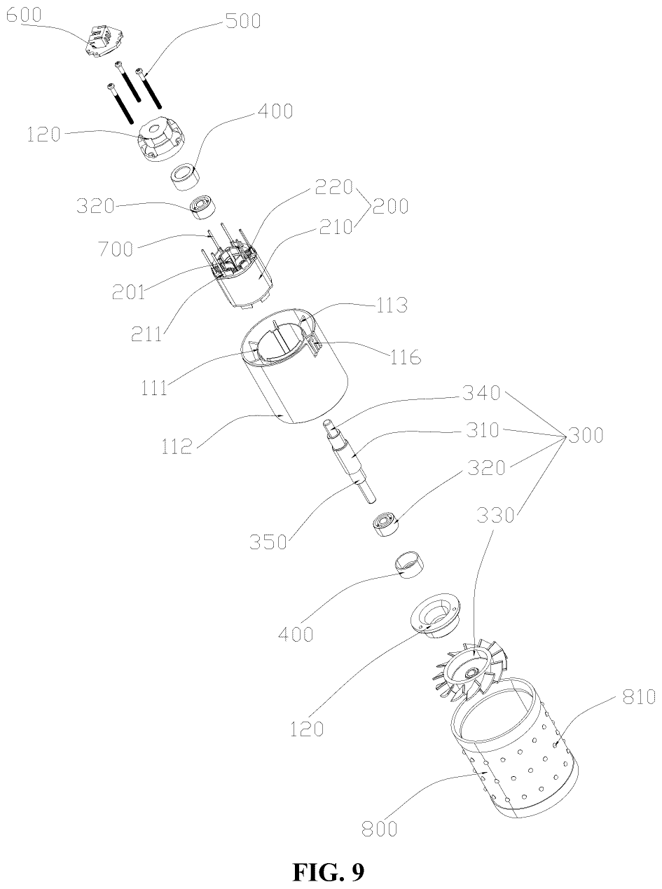

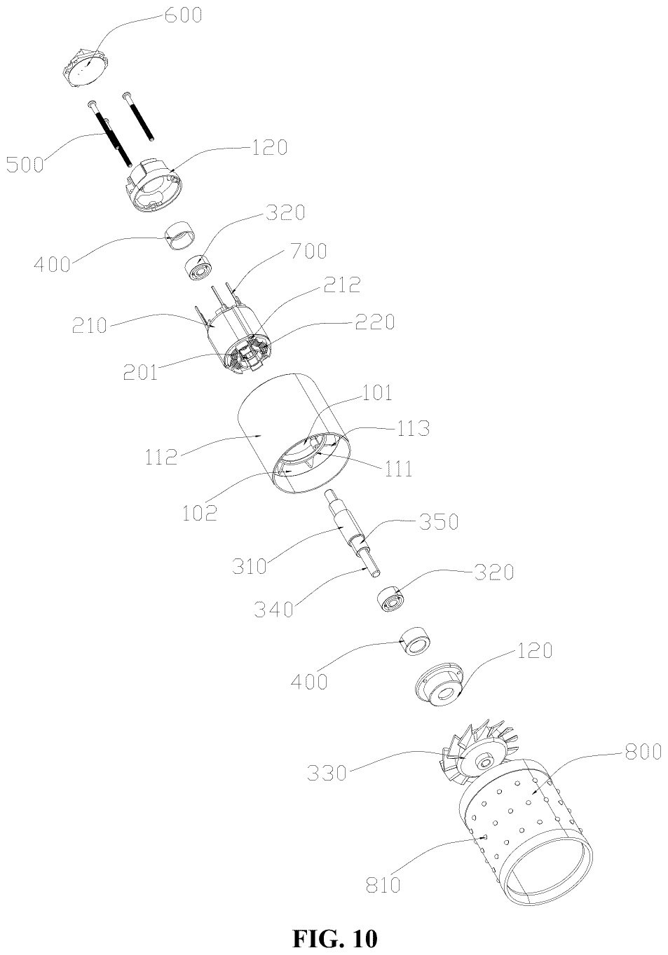

Referring to FIG. 1 to FIG. 10, an electric motor includes:
a frame assembly 100, wherein the frame assembly 100 includes a shell 110 and at least one bearing frame 120; the shell 110 has an inner wall 111 and an outer wall 112; the inner wall 111 defines a mounting channel 101; an annular channel 102 is defined between the inner wall 111 and the outer wall 112; diffuser vanes 113 are arranged in the annular channel 102; the bearing frame 102 is connected to an end portion of the shell 110;
a stator assembly 200, wherein the stator assembly 200 is arranged in the mounting channel 101; the stator assembly 200 includes a stator shell 210 and a coil assembly 220; the stator assembly 200 defines a mounting hole 201; and
a rotor assembly 300, wherein the rotor assembly 300 includes a magnet 310, a bearing 320, an impeller 330, and a rotating shaft 340; the rotor assembly 300 is at least partially inserted into the mounting hole 201; and the bearing 320 is inserted into a mounting slot 121 of the bearing frame 120.

By the arrangement of the above structure, the stator assembly 200 is inserted into the mounting channel 101, and then the rotor assembly 300 is inserted into the mounting hole 201, so that the stator assembly 200 and the rotor assembly 300 are coaxially arranged. In addition, the bearing frame 120 is connected to the shell 110, and the bearing 320 of the rotor assembly 300 is inserted into the mounting slot 121 of the bearing frame 120, so that the bearing frame 120 can connect the rotor assembly 300 with the shell 110, and the product connection is more stable. Moreover, the shell 110 and the bearing frame 120 separately arranged, which can reduce the production difficulty, improve the production efficiency, and increase the yield of the product. When in use, alternating current is provided to the coil assembly 220 to generate a periodically changing magnetic field. The magnetic field generated by coil assembly 220 interacts with a magnetic field of the magnet 310, thereby driving the magnet 310, the rotating shaft 340, and the impeller 330 to rotate.

In this embodiment, the bearing frame 120 is provided with a connecting portion 122 and an insertion portion 123; the mounting slot 121 is arranged in the insertion portion 123; the connecting portion 122 extends outwards along an edge of the insertion portion 123; and the connecting portion 122 is connected to an end portion of the shell 110. By the arrangement of the above structure, the connecting portion 122 of the bearing frame 120 is connected to the end portion of the shell 110, which can fix the bearing frame 120 and the shell 110 and improve the stability of the product. The mounting slot 121 provided in the insertion portion 123 allows the bearing 320 to be mounted, so as to connect the rotor assembly 300 with the bearing frame 120.

In this embodiment, the connecting portion 122 is provided with a through hole 124, and the through hole 124 is configured to allow an air flow to pass through. By the arrangement of the above structure, during use, the impeller 330 rotates to generate an air flow. The air flow can pass through the through hole 124 and flow through the rotor assembly 300 and the stator assembly 200, which can effectively bring away heat generated during operation, reduce temperatures of the rotor assembly 300 and the stator assembly 200, prolong the service life of the product, and improve the safety of the product.

In this embodiment, the electric motor further includes a shock absorber sleeve 400; the shock absorber sleeve 400 sleeves the bearing 320; an inner surface of the shock absorber sleeve 400 abuts against an outer surface of the bearing 320; an outer surface of the shock absorber sleeve 400 is in contact with an inner wall of the mounting slot 121. By the arrangement of the above structure, the shock absorber sleeve 400 is arranged between the bearing 320 and the mounting slot 121 during use, which can effectively provide buffering. When the rotating shaft 340 rotates relative to the bearing 320, the collision between the bearing 320 and the mounting slot 121 can be relieved, the service lives of the various components can be prolonged, the noise can be reduced, and a user experience is good.

In this embodiment, the insertion portion 123 is provided with a shaft hole 125; an output end of the rotating shaft 340 is threaded out along the shaft hole 125, and the impeller 330 is connected to the output end of the rotating shaft 340. By the arrangement of the above structure, the output end of the rotating shaft 340 is threaded out along the shaft hole 125 and is connected to the impeller 330, and the rotation of the rotating shaft 340 drives the impeller 330 to rotate, thereby generating the air flow. The impeller 330 is located below the bearing 320 and the bearing frame 120, which can maintain the structural stability and facilitate the mounting.

In this embodiment, a lower part of the inner wall 111 of the shell 110 protrudes inwards to form a mounting block 114; the mounting block 114 is provided with a first connecting hole 103; the bearing frame 120 is provided with a second connecting hole 126; and the first connecting hole 103 and the second connecting hole 126 are configured to allow a threaded connector 500 to be inserted and connected, so that the bearing frame 120 is connected to the shell 110. By the arrangement of the above structure, during use, the threaded connector 500 is threaded into the second connecting hole 126 on the upper bearing frame 120, then passes through the first connecting hole 103, and is in threaded connection to the second connecting hole 126 on the lower bearing frame 120, to achieve the connection between the upper and lower bearing frames 120 and the shell 110. The connection is convenient and stable.

In this embodiment, the stator shell 210 is further provided with a connecting through hole 212; a threaded portion of the threaded connector 500 passes through the second connecting hole 126 and the connecting through hole 212, and is in threaded connection to the first connecting hole 103; a lower surface of the upper bearing frame 120 resists against an upper surface of the stator shell 210; and a lower surface of the stator shell 210 resists against the mounting block 114. By the arrangement of the above structure, during use, the threaded connector 500 is threaded into the second connecting hole 126 on the upper bearing frame 120, then passes through the connecting through hole 212 and the first connecting hole 103, and is in threaded connection to the second connecting hole 126 on the lower bearing frame 120, to achieve the connection between the upper and lower bearing frames 120, the stator shell 210, and the shell 110. The connection is convenient and stable. Furthermore, a plurality of components are connected together, so that the structure of the product is more stable and firmer.

In this embodiment, a first mounting step 115 is arranged at an edge of the shell 110; a second mounting step 127 is arranged at an edge of the bearing frame 120; and the first mounting step 115 resists against the second mounting step 127. By the arrangement of the above structure, during use, a protruding portion of the first mounting step 115 resists against a recessed portion of the second mounting step 127, and a recessed portion of the first mounting step 115 resists against a protruding portion of the second mounting step 127, so as to achieve positioning of the shell 110 and the bearing frame 120, align the bearing frame 120 with the shell 110, and facilitate the mounting of the bearing frame 120. Meanwhile, the radial movement of the bearing frame 120 can be limited too, thereby improving the stability of the product.

In this embodiment, the electric motor further includes a PCB 600; the PCB 600 is connected to an upper surface of the upper bearing frame 120 and is electrically connected to the coil assembly 220. By the arrangement of the above structure, the PCB 600 can be stably connected to the upper surface of the upper bearing frame 120, making it convenient for a user to mount the PCB 600 and improve the stability of the product. In addition, the PCB 600 is electrically connected to each coil assembly 220, so that the PCB 600 can control a magnitude, direction, and cycle of current in each coil assembly 220, to adjust a speed of the motor.

In this embodiment, the rotor assembly 300 further includes two shaft sleeves 350; the magnet 310 sleeves the rotating shaft 340; and the two shaft sleeves 350 sleeve the rotating shaft 340 and respectively resist against two ends of the magnet 310. By the arrangement of the above structure, during use, the magnet 310 sleeve the rotating shaft 340 to achieve preliminary connection between the magnet 310 and the rotating shaft 340. Then, the two shaft sleeves 350 can be connected to the two ends of the magnet 310 to limit the magnet 310, thereby hindering the axial movement of the magnet 310 and improving the stability of the product.

In this embodiment, the electric motor further includes several electric connection pins 700; several electric contacts 211 electrically connected to the coil assembly 220 are arranged on an upper surface of the stator shell 210; lower ends of the electric connection pins 700 are electrically connected to the electric contacts 211; and upper ends of the electric connection pins 700 are electrically connected to the PCB 600. By the arrangement of the above structure, during use, the two ends of the electric connection pins 700 are respectively connected to the PCB 600 and the electric contacts 211 on the coil assembly 220. The electric connection pins 700 pass through an edge of the upper bearing frame 120 to achieve the electric connection between the PCB 600 and each coil assembly 220, so that the PCB 600 can separately control a magnitude, direction, and cycle of current in each coil assembly 220, thereby adjusting the speed of the motor.

In this embodiment, the electric motor further includes a shock absorber shell 800. The shock absorber shell 800 sleeves an outer surface of the shell 110. By the arrangement of the above structure, the shock absorber shell 800 sleeves the outer surface of the shell 110, which can provide buffering, so that a flexible buffer component exists between the outer surface of the shell 110 and a motor mounting position, which reduces the vibration and the noise, and the user experience is better.

In this embodiment, the shock absorber shell 800 is a silica gel material, and a protruding resisting portion 810 is arranged on a surface of the shock absorber shell 800. By the arrangement of the above structure, the silica gel shock absorber shell 800 is not only inexpensive, but also sturdy and durable, which can effectively provide buffering and prolong the service life of the product. Meanwhile, the several protruding resisting portions 810 on the surface of the shock absorber shell 800 can resist against the motor mounting position, which enlarges a deformation space of the product and further provides buffering. In addition, friction can be further increased, so that the motor connection is more stable.

In this embodiment, the outer wall 112 axially extends beyond the inner wall 111 in at least one of an upstream direction and a downstream direction. By the arrangement of the above structure, the outer wall 112 axially extends upwards or downwards beyond the inner wall 111, thus forming an accommodating chamber that can accommodate the bearing frame 12, the bearing 320, and at least a portion of the impeller 330. This effectively prevents dust and other impurities from entering the bearing 320 and prolongs the service life of the product.

In this embodiment, the impeller 330 includes an impeller main body 331 and vanes 332; and the vanes 332 uniformly extend outwards along a surface of the impeller main body 331. By the arrangement of the above structure, the impeller main body 331 is connected to the output end of the rotating shaft 340. When the rotating shaft 340 rotates, the impeller main body 331 rotates with the rotating shaft 340, which in turn drives the vanes 332 to rotate to generate the air flow.

In this embodiment, the vanes 332 are located in a space encircled by the outer wall 112. By the arrangement of the above structure, the vanes 332 are arranged in the space encircled by the outer wall 112. It can effectively protect the vanes 332, prevent the vanes 332 from being in contact with dust and other components during rotation, prevent the vanes 332 from being damaged, and prolong the service life of the product. Meanwhile, it can further make the rotation of vanes 332 smoother, prevent the vanes 332 from scratching a user or other components during rotation, and improve the safety of the product.

In this embodiment, a diameter of a circle where outer surfaces of the vanes 332 are located is matched with a diameter of an inner surface of the outer wall 112. By the arrangement of the above structure, the diameter of the circle where the outer surfaces of the vanes 332 are located is matched with the diameter of the inner surface of the outer wall 112, so that the vanes 332 can be arranged in the space encircled by the outer wall, and the impeller 330 rotates more smoothly.

In this embodiment, each vane 332 is shaped like an Archimedean spiral curved surface. By the arrangement of the above structure, during the rotation, the vanes 332 shaped like the Archimedean spiral curved surfaces can more easily promote air to flow and generate the air flow. Moreover, the air flow flows along the surfaces of the vanes 332, so that little energy is lost, and the energy utilization rate of the product is increased.

In this embodiment, the diffuser vanes 113 extend along an outer surface of the inner wall 111 to the inner surface of the outer wall 112, and the diffuser vanes 113 are uniformly arranged in the annular channel 102 at intervals. By the arrangement of the above structure, air flow paths are formed between the diffuser vanes 113 spaced apart from each other, to allow the air flow to be circulated along the air flow paths and uniformly deliver the air flow. In addition, the air flow further flows through a region where the stator assembly 200 is located, thereby bringing away the heat generated by the operation of the stator assembly 200, reducing the temperature of the product during the operation, improving the safety of use of the product, and prolonging the service life of the product.

In this embodiment, an electrostatic connecting block 116 is arranged on the outer wall 112, and the electrostatic connecting block 116 is configured to be electrically connected to a conductive component to eliminate static electricity. By the arrangement of the above structure, during use, the electrostatic connecting block 116 is connected to the conductive component to transfer charges at the motor, thereby eliminating the static electricity and preventing the impact of the accumulation of static electricity on the operation of the motor.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. An electric motor, comprising:
a frame assembly, wherein the frame assembly comprises a shell and at least one bearing frame; the shell has an inner wall and an outer wall; the inner wall defines a mounting channel; an annular channel is defined between the inner wall and the outer wall; diffuser vanes are arranged in the annular channel; the bearing frame is connected to an end portion of the shell;
a stator assembly, wherein the stator assembly is arranged in the mounting channel; the stator assembly comprises a stator shell and a coil assembly; the stator assembly defines a mounting hole; and
a rotor assembly, wherein the rotor assembly comprises a magnet, a bearing, an impeller, and a rotating shaft; the rotor assembly is at least partially inserted into the mounting hole; and the bearing is inserted into a mounting slot of the bearing frame.

2. The electric motor according to claim 1, wherein the bearing frame is provided with a connecting portion and an insertion portion; the mounting slot is arranged in the insertion portion; the connecting portion extends outwards along an edge of the insertion portion; and the connecting portion is connected to an end portion of the shell.

3. The electric motor according to claim 2, wherein the connecting portion is provided with a through hole, and the through hole is configured to allow an air flow to pass through.

4. The electric motor according to claim 1, further comprising a shock absorber sleeve, wherein the shock absorber sleeve sleeves the bearing; an inner surface of the shock absorber sleeve abuts against an outer surface of the bearing; an outer surface of the shock absorber sleeve is in contact with an inner wall of the mounting slot.

5. The electric motor according to claim 2, wherein the insertion portion is provided with a shaft hole; an output end of the rotating shaft is threaded out along the shaft hole, and the impeller is connected to the output end of the rotating shaft.

6. The electric motor according to claim 1, wherein a lower part of the inner wall of the shell protrudes inwards to form a mounting block; the mounting block is provided with a first connecting hole; the bearing frame is provided with a second connecting hole; and the first connecting hole and the second connecting hole are configured to allow a threaded connector to be inserted and connected, so that the bearing frame is connected to the shell.

7. The electric motor according to claim 6, wherein the stator shell is further provided with a connecting through hole; a threaded portion of the threaded connector passes through the second connecting hole and the connecting through hole, and is in threaded connection to the first connecting hole; a lower surface of the upper bearing frame resists against an upper surface of the stator shell; and a lower surface of the stator shell resists against the mounting block.

8. The electric motor according to claim 1, wherein a first mounting step is arranged at an edge of the shell; a second mounting step is arranged at an edge of the bearing frame; and the first mounting step resists against the second mounting step.

9. The electric motor according to claim 1, further comprising a printed circuit board (PCB), wherein the PCB is connected to an upper surface of the upper bearing frame and is electrically connected to the coil assembly.

10. The electric motor according to claim 1, wherein the rotor assembly further comprises two shaft sleeves; the magnet sleeves the rotating shaft; and the two shaft sleeves sleeve the rotating shaft and respectively resist against two ends of the magnet.

11. The electric motor according to claim 9, further comprising several electric connection pins, wherein several electric contacts electrically connected to the coil assembly are arranged on an upper surface of the stator shell; lower ends of the electric connection pins are electrically connected to the electric contacts; and upper ends of the electric connection pins are electrically connected to the PCB.

12. The electric motor according to claim 1, further comprising a shock absorber shell, wherein the shock absorber shell sleeves an outer surface of the shell.

13. The electric motor according to claim 12, wherein the shock absorber shell is a silica gel material, and a protruding resisting portion is arranged on a surface of the shock absorber shell.

14. The electric motor according to claim 1, wherein the outer wall axially extends beyond the inner wall in at least one of an upstream direction and a downstream direction.

15. The electric motor according to claim 1, wherein the impeller comprises an impeller main body and vanes; and the vanes uniformly extend outwards along a surface of the impeller main body.

16. The electric motor according to claim 15, wherein the vanes are located in a space enclosed by the outer wall.

17. The electric motor according to claim 15, wherein a diameter of a circle where outer surfaces of the vanes are located is matched with a diameter of an inner surface of the outer wall.

18. The electric motor according to claim 15, wherein each vane is shaped like an Archimedean spiral curved surface.

19. The electric motor according to claim 1, wherein the diffuser vanes extend along an outer surface of the inner wall to the inner surface of the outer wall, and the diffuser vanes are uniformly arranged in the annular channel at intervals.

20. The electric motor according to claim 1, wherein an electrostatic connecting block is arranged on the outer wall, and the electrostatic connecting block is configured to be electrically connected to a conductive component to eliminate static electricity.
